(19) United States
(12) Patent Application Publication
(10) Pub. No.: US 2025/0170529 A1
(43) Pub. Date: May 29, 2025

(54) METHODS FOR MAKING CHARGED ULTRAFILTRATION MEMBRANES AND USES THEREOF IN DAIRY APPLICATIONS

(71) Applicants: fairlife, LLC, Chicago, IL (US); The Board of Trustees of The University of Alabama, Tuscaloosa, AL (US)

(72) Inventors: Stephen Michael Christopher RITCHIE, Northport, AL (US); Shakeel UR REHMAN, Naperville, IL (US); Robert Connor SCOTT, Highland Village, TX (US)

(73) Assignees: fairlife, LLC, Chicago, IL (US); The Board of Trustees of The University of Alabama, Tuscaloosa, AL (US)

(21) Appl. No.: 18/881,447

(22) PCT Filed: Jul. 6, 2023
(86) PCT No.: PCT/US2023/069696

§ 371 Date: Jan. 6, 2025

Related U.S. Application Data
(60) Provisional application No. 63/359,228, filed on Jul. 8, 2022.

(51) Int. Cl. B01D 65/08; A23C 9/142; A23C 9/15; B01D 61/14; B01D 67/00; B01D 69/02; B01D 69/10; B01D 71/28; B01D 71/68; B01D 71/82

(52) U.S. Cl. CPC B01D 65/08; A23C 9/1422; A23C 9/15; B01D 61/145; B01D 67/0088; B01D 67/00931; B01D 69/02; B01D 69/1071; B01D 71/281; B01D 71/68; B01D 71/82; B01D 2323/081; B01D 2323/216; B01D 2325/14; B01D 2325/20

(57) ABSTRACT

Charged ultrafiltration membranes are synthesized by thermally initiated free-radical polymerization of sodium styrene sulfonate in the pores of an ultrafiltration pre-cursor membrane. The resulting grafted chains of the charged UF membrane provide significant negative charge to maintain nearly complete rejection of proteins at significantly higher flux.

### REFERENCE TO RELATED APPLICATION

This application is being filed on Jul. 6, 2023, as a PCT International Patent Application and claims the benefit of and priority to U.S. Provisional Patent Application No. 63/359,228, filed on Jul. 8, 2022, the disclosure of which is incorporated herein by reference in its entirety.

### BACKGROUND OF THE INVENTION

The present invention relates generally to the use of ultrafiltration membranes for fractionating aqueous streams containing protein, sugar, and minerals. The protein is retained by the membrane, while sugar, minerals, and water permeate through the membrane.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Consistent with aspects of this invention, a method for making an ultrafiltration membrane is disclosed herein, and this method can comprise (a) contacting a pre-cursor membrane comprising a polyethersulfone (PES) and/or a polysulfone (PSF) with an aqueous solution comprising sodium styrene sulfonate and a free radical initiator, and (b) curing the pre-cursor membrane to form the ultrafiltration membrane, wherein the ultrafiltration membrane has sulfonated polystyrene bound in pores and/or bound on an external surface of the ultrafiltration membrane.

Ultrafiltration membranes also are encompassed herein. Generally, the ultrafiltration membranes can comprise (I) a polyethersulfone (PES) and/or a polysulfone (PSF) membrane, and (II) sulfonated polystyrene bound in pores and/or bound on an external surface of the ultrafiltration membrane. More often, the ultrafiltration membrane further includes a mechanical support layer positioned underneath (and attached to) the membrane. The mechanical support layer can comprise a polypropylene (PP) or a polyester (PET), such as a non-woven PP or PET.

In accordance with other aspects of this invention, ultrafiltration modules and milk fractionation systems are provided herein. A representative ultrafiltration module can comprise (1) an inlet for a feed stream (e.g., a dairy product such as whole or skim milk), (2) one or more of any of the ultrafiltration membranes disclosed herein in any suitable configuration, such as a hollow fiber configuration, a tubular configuration, or a spiral wound configuration, (3) a first outlet for a UF retentate stream, and (4) a second outlet for a UF permeate stream. A representative milk fractionation system can comprise (A) one or more than one of any of the ultrafiltration modules disclosed herein, (B) a nanofiltration module, and (C) a reverse osmosis module.

Methods for making a dairy composition also are encompassed herein. One such method can comprise (i) ultrafiltering a milk product using any of the ultrafiltration membranes disclosed herein (or any of the ultrafiltration modules disclosed herein) to produce a UF permeate fraction and a UF retentate fraction, (ii) nanofiltering the UF permeate fraction to produce a NF permeate fraction and a NF retentate fraction, (iii) subjecting the NF permeate fraction to a reverse osmosis step to produce a RO permeate fraction and a RO retentate fraction, and (iv) combining at least two of the UF retentate fraction, the RO permeate fraction, the RO retentate fraction, and a fat-rich fraction to form the dairy composition.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to these figures in combination with the detailed description and examples.

FIG. 1 is a scanning electron microscope (SEM) photograph of a pre-cursor membrane containing a top layer of PSF and a bottom mechanical support layer.

FIG. 2 presents an illustration of polystyrene bound in the pores of the ultrafiltration membrane.

FIG. 3 presents a representative schematic diagram of diffusion of the aqueous reaction solution into the pores of the pre-cursor membrane prior to curing.

FIG. 4 presents a bar chart of water permeability for pre-cursor membranes and ultrafiltration membranes described in Examples 1-5.

FIGS. 5-6 present bar charts of protein rejection for pre-cursor membranes and ultrafiltration membranes described in Examples 1-5.

FIG. 7 is a photograph of a methylene blue dye uptake by the modified PS35 ultrafiltration membrane of Example 5 at different curing times (cook times) at 100° C.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the systems, compositions, processes, and/or methods described herein are contemplated with or without explicit description of the particular combination.

Additionally, unless explicitly recited otherwise, any aspect and/or feature disclosed herein can be combined to describe inventive systems, compositions, processes, and/or methods consistent with the present invention.

In this disclosure, while compositions and methods and systems are often described in terms of “comprising” various materials or steps or components, the compositions and methods and systems also can “consist essentially of” or “consist of” the various materials or steps or components, unless stated otherwise.

The terms “a,” “an,” and “the” are intended to include plural alternatives, e.g., at least one, unless otherwise specified. For instance, the disclosure of “an ultrafiltration membrane” is meant to encompass one or more than one ultrafiltration membrane, unless otherwise specified.

In the disclosed methods, the terms “combining” and “contacting” encompass the combining or contacting of materials in any order, in any manner, and for any length of time, unless otherwise specified. For example, the materials can be blended, mixed, treated, impregnated, and the like.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the aqueous reaction solution in step (a) can contain from 1 to 25 wt. % sodium styrene sulfonate in aspects of this invention. By a disclosure that the aqueous solution contains from 1 to 25 wt. % sodium styrene sulfonate, the intent is to recite that the weight percent can be any amount in the range and, for example, can include any range or combination of ranges from 1 to 25 wt. %, such as from 2 to 20 wt. % sodium styrene sulfonate, or from 5 to 15 wt. % sodium styrene sulfonate, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

Disclosed herein are ultrafiltration membranes that comprise a polyethersulfone (PES) and/or a polysulfone (PSF) membrane, and sulfonated polystyrene bound in pores and/or bound on an external surface of the ultrafiltration membranes; methods for producing the ultrafiltration membranes; ultrafiltration modules containing a plurality of the ultrafiltration membranes; milk fractionation systems containing a plurality of the ultrafiltration modules; and methods for making dairy compositions utilizing the ultrafiltration membranes and the ultrafiltration modules.

Ultrafiltration (UF) membranes are typically described by their molecular weight cut-off (MWCO, the molecular weight or size of the molecule that is retained by the membrane). For instance, for separating and concentrating proteins in the dairy industry, the MWCO for an ultrafiltration membrane can be 10 kDa, such that at least 90% of materials having molecular weights greater than 10,000 Daltons are retained (retentate), while lower molecular weight species pass through (permeate).

An objective of this invention is to produce an ultrafiltration membrane that maintains a high level of protein rejection, but does so at higher overall flux. Thus, the membrane would retain the same amount of protein at a higher throughput. For instance, the charged ultrafiltration membrane disclosed herein can retain protein at the same level as a standard 10 kDa MWCO ultrafiltration membrane, but with substantially higher flux (e.g., from 20 to 70% higher). This is accomplished by modifying a pre-cursor PES or PSF membrane with bonded sulfonated polystyrene functional groups to form a charged polymer membrane, which rejects protein based both on molecular size and charge.

This objective is directed primarily to dairy applications, such as milk-based beverages and related products, due a large constituent being protein. However, the methods, techniques, membranes, and so forth that are described herein are not limited solely to milk or dairy applications, and can be applied also to non-alcoholic and alcoholic beverages generally including, but not limited to beer, wine, water, waste-water processing, juice, oat, almond/nut, pea, rice, seeds, grains and other plant material processing, and to end-use applications and products based on these materials.

Another objective of this invention is to form the charged polymeric membrane using a free-radical polymerization process, instead of a cationic polymerization process that yields an ionic bond between polymer chains and the pre-cursor membrane. While any curing method can be used, in certain aspects, a thermal initiator is used for thermal curing of the free-radical polymerization process, thereby forming the charged UF membrane.

Yet another objective of this invention is to form the charged polymeric membrane in a straightforward synthesis scheme with a limited number of process steps, and in this case, via the use of sodium styrene sulfonate directly. Moreover, glycerin can be included in the aqueous reaction solution, along with sodium styrene sulfonate, to promote and maintain wetting of the substrate membrane and pores.

While this invention is described in detail in relation to ultrafiltration (UF) membranes and methods of their manufacture, the methods and techniques disclosed herein also are applicable to microfiltration (MF) membranes, as well as to nanofiltration (NF) and reverse osmosis (RO) and forward osmosis (FO) membranes, and accordingly, MF membranes—and NF and RO and FO membranes—with bound sulfonated polystyrene moieties are encompassed herein.

In addition to the food processing applications noted above, other non-limiting uses for charged membranes (e.g., charged UF membranes, charged MF membranes) can include bacterial removal, virus removal, fermentation processes, ion exchange, isolation of rare elements, and isolation of charged paint particles, among other end-use applications.

### Ultrafiltration Membranes

Various methods for making ultrafiltration membranes are provided herein. For instance, a method of making an ultrafiltration membrane can comprise (or consist essentially of, or consist of) (a) contacting a pre-cursor membrane comprising a polyethersulfone (PES) and/or a polysulfone (PSF) with an aqueous solution comprising sodium styrene sulfonate and a free radical initiator, and (b) curing the pre-cursor membrane to form the ultrafiltration membrane, wherein the ultrafiltration membrane has sulfonated polystyrene bound in pores and/or bound on an external surface of the ultrafiltration membrane.

Generally, the features of any of the methods disclosed herein (e.g., the PES polymer, the PSF polymer, the composition of the aqueous solution, the curing process, and the temperature and time conditions under which any steps are performed, among others) are independently described herein, and these features can be combined in any combination to further describe the disclosed methods. Moreover, other process steps can be conducted before, during, and/or after any of the steps listed in the disclosed methods, unless stated otherwise. Additionally, any ultrafiltration membranes produced in accordance with any of the disclosed methods are within the scope of this disclosure and are encompassed herein.

Referring now to step (a), any suitable pre-cursor membrane that comprises a polyethersulfone (PES) polymeric material and/or a polysulfone (PSF) polymeric material can be utilized. Generally, the pre-cursor PES and PSF membranes have a pure water permeability that is at least 20% greater than a standard 10 kDa MWCO PES membrane. The pre-cursor membrane can be fully wet, partially dry, or fully dry, and with or without glycerin prior to contact with the aqueous reaction solution in step (a). The pre-cursor membrane can be unsupported or supported, and when supported, typically on a PP or PET non-woven material.

The aqueous solution in step (a) contains a monomer, typically sodium styrene sulfonate, and a free radical initiator. While not limited thereto, the aqueous solution often contains from 1 to 25 wt. % sodium styrene sulfonate in one aspect, from 2 to 20 wt. % sodium styrene sulfonate in another aspect, and from 5 to 15 wt. % sodium styrene sulfonate in yet another aspect. The amount of sodium styrene sulfonate present in the aqueous solution in step (a) often can be limited by the desired amount of diffusion into the pores or the desired extent of the reaction. For example, too much grafted polymer may form, thereby resulting in too much flux loss.

Likewise, the amount of the free radical initiator in the aqueous solution is not particularly limited. Typical ranges include, but are not limited to, from 0.1 to 5 wt. %, from 0.2 to 4 wt. %, or from 0.5 to 2.5 wt. % free radical initiator, based on the weight of the aqueous solution. The amount of the free radical initiator often can depend upon the amount of sodium styrene sulfonate present in the solution, the type of curing used in step (b), and the prevailing temperature, among other considerations.

Any suitable free radical initiator can be used in the aqueous solution, but the type of initiator can depend upon the type of curing used in step (b). For thermal curing, a representative and non-limiting example of a suitable curing agent is potassium persulfate, which beneficially is both thermally activated and water soluble. Other suitable alternatives include sodium persulfate and ammonium persulfate, which are both water soluble. Non-water soluble initiators, such as azobisisobutyronitrile (AIBN), also can be used, but generally with a suitable co-solvent, typically a water soluble alcohol.

Optionally, the aqueous solution can further comprise glycerin. While not wishing to be bound by theory, it can be advantageous in order to improve pore wetting and to prevent pores from drying out to have a small amount of glycerin present in the aqueous solution, generally from as little as 0.1 wt. % ranging up to and including 15-20 wt. %. More often, the aqueous solution contains from 0.2 to 8 wt. %, from 0.5 to 5 wt. %, or from 3 to 15 wt. % glycerin, when glycerin is being utilized.

Step (a) can be performed at any suitable temperature, such as from 10° C. to 90° C., from 20° C. to 70° C., from 15° C. to 55° C., from 20° C. to 45° C., or from 20° C. to 30° C., although not limited thereto. In these and other aspects, these temperature ranges also are meant to encompass circumstances where step (a) is conducted at a series of different temperatures, instead of at a single fixed temperature, wherein at least one temperature falls within the respective ranges. The pressure at which step (a) is conducted is not particularly limited, but can be at an elevated pressure (e.g., from 5 psig to 100 psig), at atmospheric pressure, or at any suitable sub-atmospheric pressure. In some instances, step (a) is conducted at atmospheric pressure, eliminating the need for pressurized vessels and their associated cost and complexity. Step (a) can be performed for any time period sufficient for the aqueous solution to diffuse and/or wick into pores of the pre-cursor membrane. Illustrative and non-limiting time periods include a wide range of time periods, such as from 10 sec to 6 hr, from 10 sec to 2 min, from 15 sec to 5 hr, from 30 sec to 2 hr, from 1 min to 24 hr, from 1 min to 1 hr, from 5 min to 6 hr, from 15 min to 5 hr, or from 30 min to 2 hr, but is not limited solely to these time periods. Other appropriate temperature, pressure, and time ranges are readily apparent from this disclosure.

Any suitable vessel or container can be used for step (a), so long as the vessel or container is capable of contacting (e.g., submerging) the pre-cursor membrane in the aqueous solution, e.g., for a time period sufficient for the aqueous solution to diffuse and/or wick into pores of the pre-cursor membrane. Step (a) can be performed batchwise or continuously.

Prior to step (a), the pre-cursor membrane can be dry in one aspect of this invention, while in another aspect, the pre-cursor membrane can be wet prior to step (a), and in yet another aspect, the pre-cursor membrane can be dry prior to step (a) but additionally wetted in water prior to step (a).

After step (a) has been performed—the pre-cursor membrane has been contacted with the aqueous solution—but before step (b), the pre-cursor membrane can be partially dried. In particular, prior to step (b), excess water can be removed from the pre-cursor membrane. The pre-cursor is only partially dried, such that a suitable amount of water (and sodium styrene sulfonate monomer and initiator) remain in the pores.

Referring now to step (b), the pre-cursor membrane is cured to form the ultrafiltration membrane, and the ultrafiltration membrane therefore contains sulfonated polystyrene bound in pores and bound on an external surface of the ultrafiltration membrane. Sulfonated polystyrene is used herein to encompass substituted styrenic moieties, e.g., methylated polystyrene groups.

Any suitable curing method can be utilized in step (b), such as subjecting the pre-cursor membrane to UV radiation (UV photoinitiation) or to electron beam radiation. However, it was determined herein that the pre-cursor membrane can be conveniently cured with heat. Hence, in one aspect of this invention, curing in step (b) can comprise subjecting the pre-cursor membrane to an elevated temperature, which typically falls within a range from 70 to 200° C., although not limited thereto. Other suitable temperature ranges include from 70 to 150° C., from 95 to 180° C., or from 80 to 130° C. In these and other aspects, these temperature ranges also are meant to encompass circumstances where the thermal curing is performed at a series of different temperatures, instead of at a single fixed temperature, wherein at least one temperature falls within the respective ranges. The maximum cure temperature often can depend upon the melting or softening point of the polyethersulfone (PES) and/or the polysulfone (PSF) used for the pre-cursor membrane as well as that of any support layer (e.g., which may be PP-based or PET-based).

In one aspect, after step (b), the ultrafiltration membrane can be rinsed with water, and this can occur in the same location as that of step (b) or in a separate location. In another aspect, the ultrafiltration membrane after step (b) can rinsed with water, contacted with an aqueous glycerin solution, and then dried.

Consistent with aspects of this invention, the pre-cursor membrane and the ultrafiltration membrane can further contain a mechanical support layer positioned underneath (and attached to) the respective membrane. This additional layer generally is present before step (a). The mechanical support layer can be constructed of any suitable material, but often is PP-based or PET-based, such as a non-woven PP or a non-woven PET. As above, depending upon the composition of the mechanical support layer and its melting or softening temperature, the curing temperature in step (b) may be varied. For a broader pH range during use of the membrane, PP often can be used as the support layer.

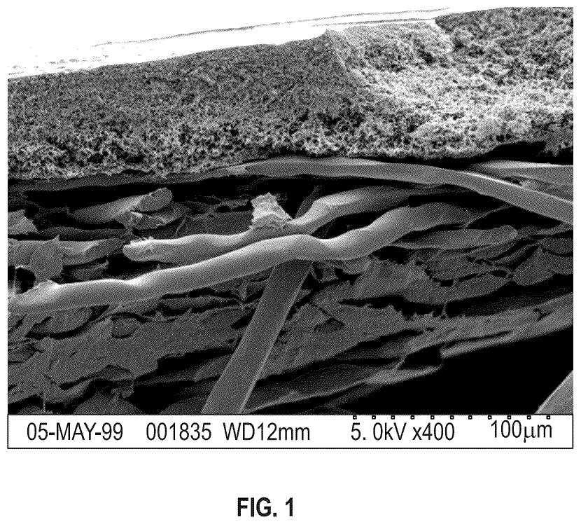

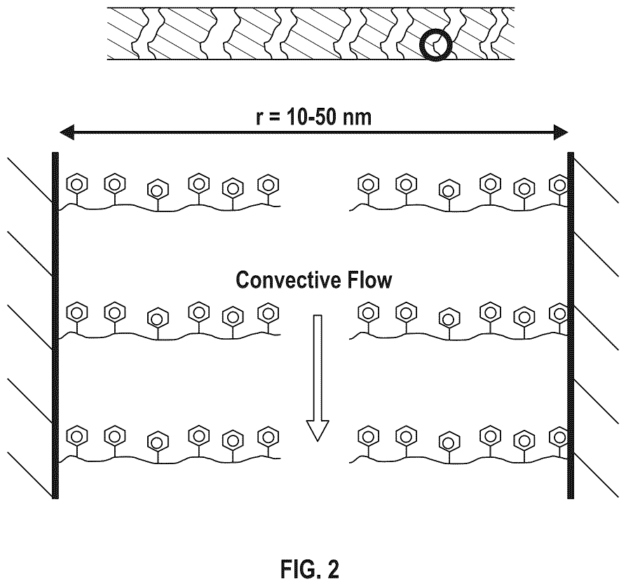

Also encompassed herein are ultrafiltration membranes that can comprise (I) a polyethersulfone (PES) and/or a polysulfone (PSF) membrane, and (II) sulfonated polystyrene bound in pores and/or bound on an external surface of the ultrafiltration membrane. These ultrafiltration membranes can be produced in accordance with any of the methods and processes described herein. Further, the ultrafiltration membrane can contain, and often does contain, a mechanical support layer positioned underneath (and attached to) the membrane. As above, suitable PP or PET non-woven materials typically are used as the mechanical support layer. A photograph of a representative pre-cursor membrane is shown in FIG. 1, with a top layer of PES or PSF and a bottom mechanical support layer of PP or PET. Generally, the layers are interconnected such that the 2 -layer configuration does not delaminate. FIG. 2 illustrates polystyrene bound in the pores of the ultrafiltration membrane (the sulfonic acid or sulfonate groups are not shown explicitly, only the polystyrene grafts).

In an aspect, the disclosed ultrafiltration membranes can be characterized by a water permeability that is at least 20% greater, and in some instances, at least 25% greater, at least 30% greater, at least 40% greater, at least 50% greater, at least 100% greater, or at least 200% greater, than that of a 10 kDa molecular weight cutoff (MWCO) membrane. Additionally or alternatively, the ultrafiltration membranes disclosed herein can be characterized by a water permeability of at least 120 L/m²-hr-bar, such as at least 150, at least 200, at least 250, at least 300, at least 500, or at least 1000 L/m²-hr-bar. Water permeability testing is further described in the examples that follow.

In an aspect, the disclosed ultrafiltration membranes can be characterized by a percent rejection of whey protein that is greater than or equal to that for a 10 kDa MWCO membrane, which is typically in excess of 90% in practice. Additionally or alternatively, the ultrafiltration membranes disclosed herein can be characterized by a percent rejection of whey protein of at least 90%, and in some instances, at least 92%, or at least 95%, for the second 5 mL (10 mL) and the third 5 mL (15 mL) sample increments. Whey protein rejection testing is further described in the examples that follow.

To determine if sulfonated polystyrene grafts are not covalently bound in the pores of the membrane, the membrane can be subjected to a high concentration brine extraction, which would disrupt electrostatic interactions used for a cationic polymerized material. Then, the extraction can be analyzed by UV-Vis and it would have a peak in the 270-300 nm range (the aromatic ring of the sulfonated polystyrene can be identified in this nm range). This indicates that grafts are leaching from the membrane, which is unacceptable for food applications, because the grafts could end up in the product stream. In contrast, ultrafiltration membranes (with covalent attached sulfonated polystyrene) would not have an absorbance in this wavelength range, due to covalent bonding.

### Systems and Processes That Utilize Ultrafiltration Membranes

The disclosed UF membranes, which contain sulfonated polystyrene bound in pores and/or bound on an exterior surface of the UF membrane, can be utilized in various apparatus, systems, and processes. One such apparatus is an ultrafiltration module that can comprise (1) an inlet for a feed stream, (2) one or more of any of the ultrafiltration membranes disclosed herein in any suitable configuration, such as a hollow fiber configuration, a tubular configuration, or a spiral wound configuration, (3) a first outlet for a UF retentate stream, and (4) a second outlet for a UF permeate stream. The feed stream that enters the ultrafiltration module through the inlet can be any suitable dairy product, such as whole milk or skim milk, although not limited thereto. Generally, the ultrafiltration module employs a plurality of ultrafiltration membranes, for instance, in a spiral wound configuration.

A representative milk fractionation system can comprise (A) one or more than one of any of the ultrafiltration modules disclosed herein, (B) a nanofiltration module, and (C) a reverse osmosis module. Other milk fractionation systems encompassed herein can comprise one or more than one of any of the ultrafiltration modules disclosed herein, a nanofiltration module, and a forward osmosis module; alternatively, one or more than one of any of the ultrafiltration modules disclosed herein and a nanofiltration module; alternatively, one or more than one of any of the ultrafiltration modules disclosed herein and a reverse osmosis module; or alternatively, one or more than one of any of the ultrafiltration modules disclosed herein and a forward osmosis module. Typically, the milk fractionation system employs a plurality of ultrafiltration modules.

Also provided herein are methods for making a dairy composition in which an ultrafiltration membrane is employed. An illustrative method can comprise (i) ultrafiltering a milk product using any of the ultrafiltration membranes disclosed herein (or any of the ultrafiltration modules disclosed herein) to produce a UF permeate fraction and a UF retentate fraction, (ii) nanofiltering the UF permeate fraction to produce a NF permeate fraction and a NF retentate fraction, (iii) subjecting the NF permeate fraction to a reverse osmosis step to produce a RO permeate fraction and a RO retentate fraction, and (iv) combining at least two of the UF retentate fraction, the RO permeate fraction, the RO retentate fraction, and a fat-rich fraction to form the dairy composition. For instance, the dairy composition can contain at least the UF retentate fraction and the RO retentate fraction in one aspect, and the dairy composition can contain at least the UF retentate fraction, the RO retentate fraction, and the fat-rich fraction (cream) in another aspect.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims. The general procedure for preparing the ultrafiltration membrane was as follows. First, a 4.70 cm diameter pre-cursor membrane sample, which was either a polyethersulfone (PES) or a polysulfone (PSF) having a nominal MWCO in the 10-20 kDa range, was forcefully wetted—with the membrane side facing up—with water in a dead-end flow cell at 90 psig for a specified time. For pre-cursor membranes with a nominal 10-20 kDa MWCO, the time duration was 2 min.

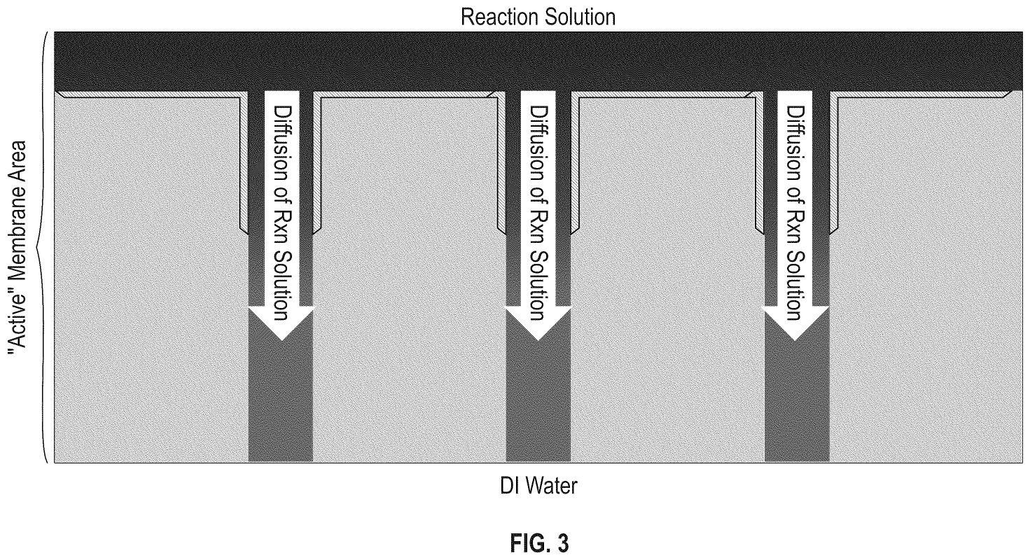

The pre-cursor membrane was removed from the dead-end cell, and submerged and soaked for 1 hr at ambient temperature and pressure in an aqueous reaction solution containing ˜15.87 wt. % sodium styrene sulfonate, ˜0.79 wt. % potassium persulfate, and ˜83.33 wt. % deionized (DI) water solution containing 5 vol % glycerin. A representative schematic diagram of diffusion of the aqueous reaction solution into the pores of the pre-cursor membrane is illustrated in FIG. 3. Diffusion is one mechanism for getting the monomer into the pores, while another mechanism is to wick the aqueous reaction solution into open, dry pores. The dry pores also may be partially filled with glycerin from the drying process.

After 1 hr, the impregnated membrane was removed from the solution, and placed membrane side up on a polypropylene mesh on top of a glass plate, which was placed in an oven at ˜100° C. and thermally-cured for 1 hr. After removing the cured ultrafiltration membrane from the oven and cooled, the membrane was placed in DI water and forcefully rinsed in a dead-end flow cell at 90 psig for 2 min. Next, the ultrafiltration membrane was submerged and soaked for 30 min in a DI water solution containing 5 vol % glycerin, removed from the glycerin solution, and dried.

The pre-cursor membranes were obtained from Solecta, Inc., and are summarized in Table 1, as well as the ultrafiltration membranes prepared with bound sulfonated polystyrene groups.

TABLE 1

| Example | Material and Support | Nominal MWCO |
|---|---|---|
| Example 1-PE10 | PES on PET | 10 kDa |
| Example 2-PE20C | PES on PP | 20 kDa |
| Example 3-PE20 | PES on PP | Charged |
| | | membrane |
| Example 4-PS35C | PSF on PET | 20 kDa |
| Example 5-PS35 | PSF on PET | Charged |
| | | membrane |

Pure water permeability of the membranes of Examples 1-5 was measured on a dedicated setup with a stainless-steel membrane holder. Water permeability was measured following a 2-min spike at 90 psig. Process flux and protein rejection testing were performed for Examples 1-5 using an AMICON stirred cell. Protein rejection studies were performed with whey protein isolate in DI water at a feed concentration of 548 ppm. Solute concentrations were measured by UV-Vis spectrophotometry at 279 nm.

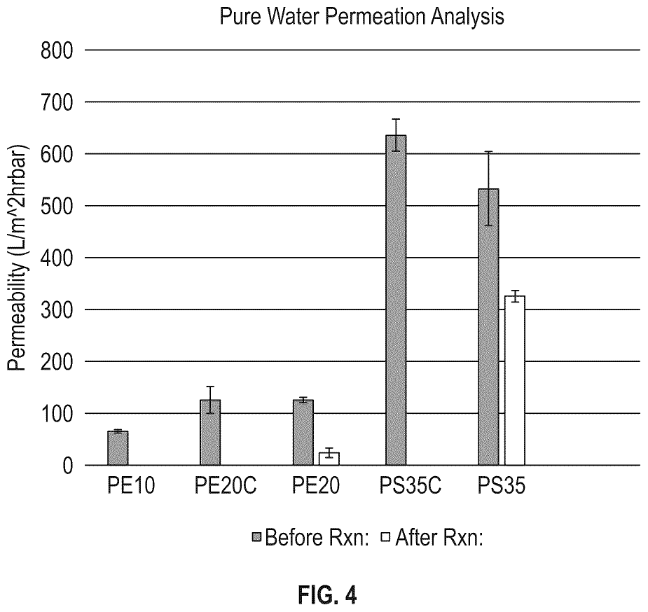

FIG. 4 summarizes the results of water permeability testing on the pre-cursor membranes and the modified ultrafiltration membranes of Examples 1-5. Flux was measured using a stainless-steel dead-end cell fed from a stainless-steel tank pressurized with compressed air. The feed pressure was initially spiked to 90 psig for 2 min to ensure full wetting of the membranes. Flux data was collected by measuring 5 pressures at a 5 psig difference, measured over 60 sec, and each pressure measurement was triplicated. The permeabilities of the pre-cursor membranes of Example 1 (PE10), Example 2 (PE20C), and Example 4 (PS35C) are shown as single bars in FIG. 4, while for Example 3 (PE20) and Example 5 (PS35), permeabilities are shown before impregnation/reaction (pre-cursor membrane) and after impregnation/reaction (charged ultrafiltration membrane).

The PE20 and PS35 membranes of Example 3 and Example 5 had much higher pure water permeability before reaction/impregnation. However, the PE20 membrane of Example 3 had much lower permeability than that of the PE10 membrane of Example 1 after reaction/impregnation. The data in FIG. 4 demonstrates the impact of the sulfonated polystyrene bound in the pores on the pore size of the membrane, and therefore the reduction in water permeability.

Unexpectedly, the PS35 membrane of Example 5 retained significantly high water permeability even after reaction/impregnation-much greater than that of the PE10 membrane of Example 1, and had a surprisingly high water permeability of over 300 L/m²-hr-bar.

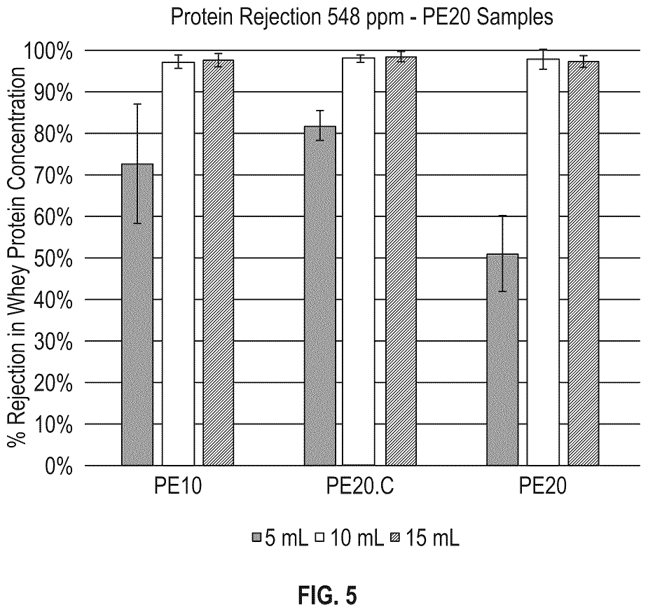

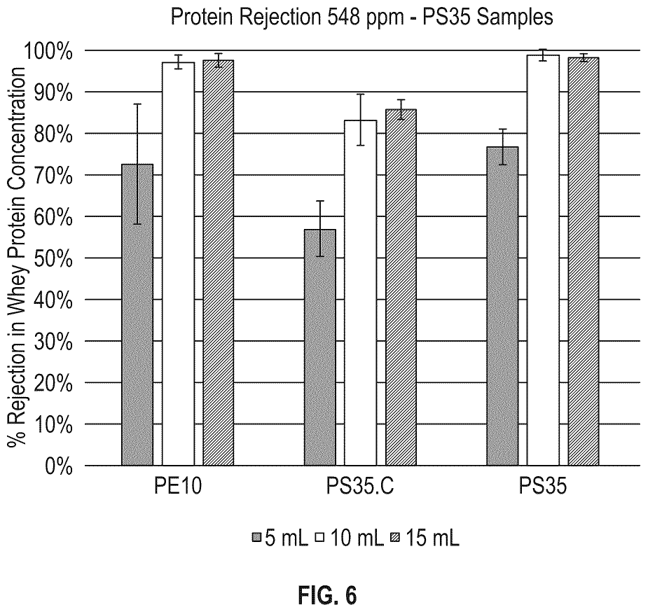

FIGS. 5-6 summarize the results of the rejection of whey protein for the pre-cursor membranes and modified ultrafiltration membranes of Examples 1-5. Protein rejection (%) was determined for the various membranes using whey protein isolate in deionized (DI) water. Rejection studies were performed using a dead-end AMICON stirred cell loaded with ˜50 mL of whey protein solution, with the stirrer set on 3, and with an applied pressure of 50 psig. The whey protein feed concentration was 548 ppm and permeates were collected in fractions to differentiate the initial burst (first 5 mL increment) from protein rejection after membrane surface fouling. Protein concentration was determined by UV-visible spectrophotometry at 279 nm.

The percent protein rejection of the pre-cursor membranes of Example 1 (PE10), Example 2 (PE20C), and Example 4 (PS35C), and the modified/charged ultrafiltration membranes of Example 3 (PE20) and Example 5 (PS35) are shown by three bars in FIGS. 5-6. Each bar represents a 5 mL increment of permeate, thus the second bar is for the second 5 mL increment of permeate (a total of 10 mL of permeate), and the third bar is for the third 5 mL increment of permeate (a total of 15 mL of permeate) collected from the 50 mL feed volume.

The whey protein isolate rejection was quite high for all membranes tested with a feed containing 548 ppm of whey protein. For the second and third increments, all percent rejections of whey protein were in excess of 90%, with the exception of the unmodified pre-cursor membrane of Example 4 (PS35C). In FIG. 5, the rejection was lower for the first 5 mL of permeate after reaction (Example 3—PE20) than for the control membrane (Example 2—PE20C). The percent rejection for subsequent permeate fractions (the next two 5 mL of permeate) for Example 3 (PE20) were not significantly different from that of Example 1 (10 kDa MWCO PE10).

Unexpectedly, for the second and third increments, the percent rejections of whey protein were in excess of 98% for the PS35 membrane of Example 5 after reaction/impregnation-a significant improvement in protein rejection versus Example 4. In addition, the modified PS35 ultrafiltration membrane had equivalent to slightly better protein rejection as compared to the unmodified PE10 membrane of Example 1 at all sample increment data points.

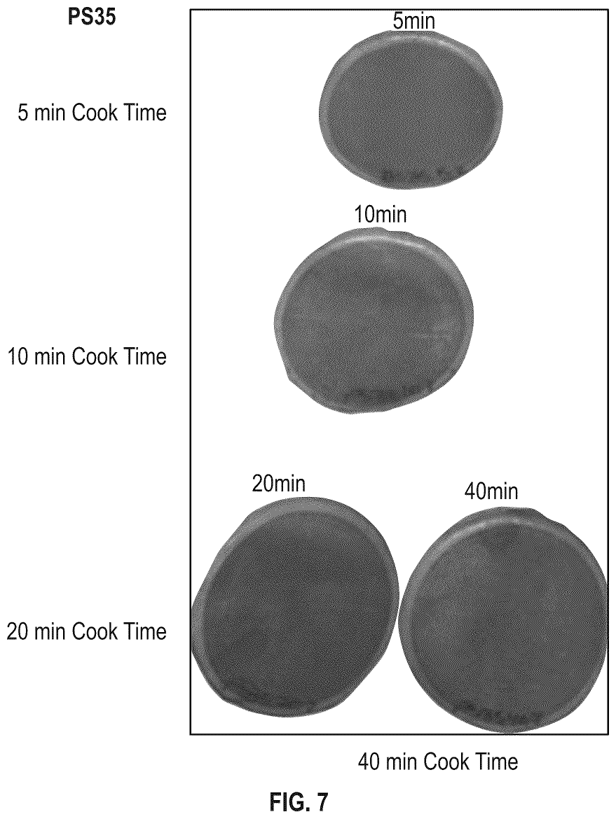

Another method for confirming the successful modification of the pre-cursor membrane is by dye adsorption. The positively charged dye is adsorbed by electrostatic interaction with the negatively charged membrane. FIG. 7 shows a photograph of a methylene blue dye uptake by the modified PS35 ultrafiltration membrane of Example 5 at different curing times (cook times) at 100° C. The methylene blue dye was retained by the sulfonated polystyrene bound in the pores of the membrane. Washing or rinsing the modified membranes with water did not remove the sulfonated polystyrene moieties from the pores of the membrane.

1. A method of making an ultrafiltration membrane, the method comprising:
(a) contacting a pre-cursor membrane comprising a polyethersulfone (PES) and/or a polysulfone (PSF) with an aqueous solution comprising sodium styrene sulfonate and a free radical initiator; and
(b) curing the pre-cursor membrane to form the ultrafiltration membrane, wherein the ultrafiltration membrane has sulfonated polystyrene bound in pores and/or bound on an external surface of the ultrafiltration membrane.

2. The method of claim 1, wherein the pre-cursor membrane is dry prior to step (a).

3. The method of claim 1, wherein the pre-cursor membrane is wet prior to step (a).

4. The method of claim 1, wherein the pre-cursor membrane is dry prior to step (a), and is wetted in water prior to step (a).

5. The method of claim 1, wherein the aqueous solution further comprises glycerin.

6. The method of claim 1, wherein the aqueous solution further comprises from 0.1 to 20 wt. %, from 0.2 to 8 wt. %, from 0.5 to 5 wt. %, or from 3 to 15 wt. % glycerin.

7. The method of claim 1, wherein the aqueous solution comprises from 1 to 25 wt. %, from 2 to 20 wt. %, or from 5 to 15 wt. % sodium styrene sulfonate.

8. The method of claim 1, wherein the aqueous solution comprises from 0.1 to 5 wt. %, from 0.2 to 4 wt. %, or from 0.5 to 2.5 wt. % free radical initiator.

9. The method of claim 1, wherein the free radical initiator comprises potassium persulfate, sodium persulfate, ammonium persulfate, or any combination thereof.

10. The method of claim 1, wherein step (a) is performed for time sufficient for the aqueous solution to diffuse and/or wick into pores of the pre-cursor membrane.

11. The method of claim 1, wherein the pre-cursor membrane is partially dried prior to step (b).

12. The method of claim 1, wherein curing in step (b) comprises subjecting the pre-cursor membrane to an elevated temperature in a range from 70 to 200° C.

13. The method of claim 1, wherein curing in step (b) comprises subjecting the pre-cursor membrane to UV radiation or electron beam radiation.

14. The method of claim 1, wherein the ultrafiltration membrane after step (b) is rinsed with water.

15. The method of claim 1, wherein the ultrafiltration membrane after step (b) is rinsed with water, contacted with an aqueous glycerin solution, and dried.

16. The method of claim 1, wherein the pre-cursor membrane and the ultrafiltration membrane comprise a mechanical support layer positioned underneath (and attached to) the respective membrane.

17. The ultrafiltration membrane prepared by the method of claim 1.

18. An ultrafiltration membrane comprising:
(I) a polyethersulfone (PES) and/or a polysulfone (PSF) membrane; and
(II) sulfonated polystyrene bound in pores and/or bound on an external surface of the ultrafiltration membrane.

19. The membrane of claim 18, wherein the ultrafiltration membrane comprises a mechanical support layer positioned underneath (and attached to) the membrane.

20. The membrane of claim 17, wherein the ultrafiltration membrane is characterized by a water permeability at least 20% greater, at least 25% greater, at least 30% greater, at least 40% greater, at least 50% greater, at least 100% greater, or at least 200% greater, than that of a 10 kDa molecular weight cutoff (MWCO) membrane.

21. The membrane of claim 17, wherein the ultrafiltration membrane is characterized by a water permeability of at least 120, at least 150, at least 200, at least 250, at least 300, at least 500, or at least 1000 L/m²-hr-bar.

22. The membrane of claim 17, wherein the ultrafiltration membrane is characterized by a percent rejection of whey protein that is greater than or equal to that for a 10 kDa MWCO membrane.

23. The membrane of claim 17, wherein the ultrafiltration membrane is characterized by a percent rejection of whey protein of at least 90%, at least 92%, or at least 95%, for second 5 mL (10 mL) and third 5 mL (15 mL) sample increments.

24. The membrane of claim 17, wherein the ultrafiltration membrane is characterized by a FTIR transmittance of less than 100% at a wavenumber (units in cm⁻¹) of 950 cm⁻¹.

25. The membrane of claim 17, wherein a high brine concentration extraction of the ultrafiltration membrane does not have an absorbance, when measured by UV-Vis at 270-300 nm.

26. An ultrafiltration module comprising:
(1) an inlet for a feed stream;
(2) one or more of the ultrafiltration membranes of claim 17 in a hollow fiber configuration, a tubular configuration, or a spiral wound configuration;
(3) a first outlet for a UF retentate stream; and
(4) a second outlet for a UF permeate stream.

27. A milk fractionation system comprising:
(A) one or more than one of the ultrafiltration modules of claim 26;
(B) a nanofiltration module; and
(C) a reverse osmosis module.

28. A method for making a dairy composition, the method comprising:
(i) ultrafiltering a milk product using the ultrafiltration membrane of claim 17 to produce a UF permeate fraction and a UF retentate fraction;
(ii) nanofiltering the UF permeate fraction to produce a NF permeate fraction and a NF retentate fraction;
(iii) subjecting the NF permeate fraction to a reverse osmosis step to produce a RO permeate fraction and a RO retentate fraction; and
(iv) combining at least two of the UF retentate fraction, the RO permeate fraction, the RO retentate fraction, and a fat-rich fraction to form the dairy composition.
